(19) United States
(12) Patent Application Publication
(10) Pub. No.: US 2012/0096291 A1
(43) Pub. Date: Apr. 19, 2012

(54) Energy-saving control apparatus, power connecting device and switching device having said apparatus

(76) Inventor: Jichang Guang, Beijing (CN)

(21) Appl. No.: 13/376,159

(22) PCT Filed: Nov. 27, 2009
(86) PCT No.: PCT/CN09/01336

§ 371 Date: Dec. 28, 2011

(30) Foreign Application Priority Data
Jun. 3, 2009 (CN) 200910085874.0

(51) Int. Cl. G06F 1/32

(52) U.S. Cl. 713/321

(57) ABSTRACT

An energy-saving control apparatus comprises a power input interface, a power output interface, a controlling unit, a sampling unit, a central processing unit and a data storage unit. The power input interface is used for connecting to an external power source. The power output interface is used for connecting to an external electric appliance. The controlling unit is used for controlling the value of the current or voltage which inputted from the power input interface to the power output interface. The controlling unit can be also used for controlling the on and off of the power output interface. The sampling unit is used for sampling and outputting the electrical parameters of the external electric appliance. The central processing unit is used for processing the output signals from the sampling unit and outputting the control signals to the controlling unit. The data storage unit stores the necessary data for the operation of the central processing unit. A power connecting device and a switching device having said energy-saving control apparatus are also provided.

### FIELD OF THE INVENTION

The present invention relates to an energy-saving control apparatus, particularly to an apparatus that performs energy-saving controls to electric appliances. The present invention also relates to applications of said energy-saving control apparatus.

### BACKGROUND OF THE INVENTION

Promoting energy saving and environment protection is a very important issue faced by various governments. Around the world, electricity has become an irreplaceable fundamental energy resource for the development of economy and society, due to its being economic, clean, practicable, and easy to transmit and control. However, the problem arises that electricity occupies a large proportion of energy consumption in various fields. The electricity industry therefore must consider how to save electrical power and to reduce the consumption during various phases such as transmitting, distribution, supplying and using electricity.

For a long time, the electricity industry has done little in the area of reducing the waste in the usage phase of electricity. One reason is that there are so many factors that cause the waste of electricity. For example, thousands of office workers are working in huge office tower complexes, using all kinds of electric office appliances and equipment, such as computers, printers, facsimile machines etc. Those machines remain on 24 hours a day and consume electricity even when the office workers are not at work. More seriously, modern office buildings are closed structures with central air conditioning, which consumes a huge amount of electrical energy every day for indoor ventilation and air conditioning and remains on even during off work hours.

There is increasing demand for a deeper level of measurement and monitoring of electricity consumption. Chinese Patent ZL02285997.7 provides an electrical-energy measuring outlet, which can easily calculate the electrical energy of electric appliances. The outlet, on which the electrical-energy measuring information is displayed, is essentially a miniature power meter, which can show people the information of the usage of electricity in real time. However, such an outlet is unable to perform an effective control to the electric appliances. Also the outlet has a bulky embodiment larger than an ordinary outlet, which makes it difficult to implement. Furthermore, said outlet is expensive.

Chinese Patent Application 200810054591.5 discloses an outlet having an electrical-energy measuring terminal. In addition to measuring the electrical-energy consumption of the electric appliances, the outlet can also transmit the measured information to the computer(s) at the place from which the request for measurement is sent out (such as the end user or the power supplying department) for a further processing such as recording, storing, analyzing, doing statistical analysis and the like. Again, this outlet is designed for the purpose of the measurement of electricity usage of the electric appliances; however, it cannot perform effective control to the appliances. Such an outlet lacks the local display of the electrical energy measurement for the sake of reducing its size and the price, which inconveniences the end users. Most importantly, such an outlet is served as one of the components of a complicated remote management system, of which the contained electrical-energy measuring terminal cannot be used alone.

To summarize, the conventional apparatuses are all based on the measurement of the electricity consumption of electrical appliances. To realize the purpose of energy saving by using those outlets, the intervention of energy conscious users is absolutely necessary.

### SUMMARY OF THE INVENTION

The problem to be solved by the invention is to provide an energy saving control apparatus which can both measure the electricity parameters and perform an effective energy-saving control to the electric appliances.

The energy saving control apparatus of the invention comprises: a power input interface for connecting to an external power source; a power output interface for connecting to an external electric appliance; a controlling unit for controlling the level of the voltage or amperage transmitted from the power input interface to the power output interface, or controlling the on and off of the power output interface; a sampling unit for collecting and outputting the electricity parameters of the external electric appliance; a central processing unit connected to the controlling unit and the sampling unit respectively to process the output signals from the sampling unit and output controlling signals to the controlling unit; and a data storage unit connected to the central processing unit to store the data necessary for the operation of the central processing unit.

Further, according to the invention, the central processing unit includes: an Analog-to-Digital (A/D) converting module connected to the sampling unit to receive and digitize the output signals from the sampling unit; an electrical energy metering module connected to the A/D converting module to calculate the electricity consumption; and a processing module, an input port of which is connected to the electrical energy metering module while an output port of which is connected to the controlling unit.

In the energy saving control apparatus according to the invention, the sampling unit includes at least one of a voltage sampling module and a current sampling module.

Further, the processing module of the central processing unit is connected to the data storage unit. The processing module can be further connected to a data output unit. The processing module can be further connected to a communication unit to exchange data with external system through said communication unit. The processing module can be further connected to a display module to display the electricity parameter of the electric appliance.

The energy saving control apparatus according to the invention also includes a button for checking the measured electricity parameter of the electric appliance.

In the energy saving control apparatus according to the invention, the controlling unit and the sampling unit can be connected in turn between the power input interface and the power output interface. Alternatively, the sampling unit and the controlling unit can be connected in turn between the power input interface and the power output interface.

Another technical problem to be solved by the invention is to provide a power connecting device equipped with the energy saving controlling apparatus, which can control each electric appliances connected thereto for the purpose of saving energy.

The power connecting device having the energy saving control apparatus comprises: a power input interface for connecting to an external power source; at least one power output interface for connecting to at least one external electrical appliance. The energy saving control apparatus comprises at least one controlling unit for controlling the level of the voltage or amperage inputted from the power output interface to the power output interface, or controlling the on and off status of the power output interface; at least one sampling unit for collecting and outputting the electricity parameters of the at least one external electric appliance; a central processing unit connected to the at least one controlling unit and the at least one sampling unit respectively to process the output signals from the at least one sampling unit and output controlling signals to the corresponding controlling unit; and a data storage unit connected to the central processing unit to store the data necessary for the operation of the central processing unit.

Further, the central processing unit includes: an A/D converting module connected to the at least one sampling unit in this device to receive and digitize the output signals from the at least one sampling unit; an electrical energy metering module connected to the A/D converting module to calculate the electricity consumption; and a processing module, an input port of which is connected to the electrical energy metering module and an output port of which is connected to the at least one controlling unit.

Each of the above-mentioned sampling units includes at least one of a voltage sampling module and a current sampling module.

Further, the processing module of the central processing unit is connected to the data storage unit. The processing module can be further connected to a data output unit. The processing module can be further connected to a communication unit in order to exchange data with an external system through said communication unit. The processing module can be also connected to a display unit.

The power connecting device of the invention also includes a button that can be used to check the measured electricity parameters of the electric appliance.

In the power connecting device of the invention, the controlling unit and the sampling unit can be in turn connected between the power input interface and the power output interface. Alternatively, the sampling unit and the controlling unit can be in turn connected between the power input interface and the power output interface.

The power connecting device according to the invention can further include a first manual switch for switching between a manual control mode and an automatic control mode, and a second manual switch cooperating with the first manual switch to control the on and off status of power output interfaces when the first manual switch is set in the manual control mode.

Yet another technical problem to be solved by the invention is to provide a switching device equipped with the energy saving control apparatus.

According to one aspect of this invention, the energy saving control apparatus of the invention provides a means of controlling the energy consumption of electrical appliances. Because the energy saving control apparatus of the invention is able to perform a feedback control to the electrical appliances based on their energy consumption status, or perform an energy-saving control to the electrical appliances based on the controlling signals from the management device, the energy saving control apparatus of the invention can be used as a stand-alone energy saving control apparatus.

According to another aspect of this invention, the energy saving control apparatus of the invention has a small profile, great integration ability and a compact structure, allowing it to be easily integrated either with the existing electrical appliances and system, or with the power connecting devices, satisfying the demands of various users.

According to yet another aspect of this invention, the energy saving control apparatus of the invention has flexibility of data output. A display module can be installed on the energy saving control apparatus of the invention for the convenience of the user to read the related data. In the case that direct displaying and reading is not convenient to the user, the energy saving control apparatus of the invention can be further equipped with a data output unit so the data can be retrieved at a short range and in a non-contact way. The data can also be transmitted via other communication media to the management system for managing purposes.

### BRIEF DESCRIPTION OF THE DRAWINGS

Reference will now be made in detail to embodiments of the present invention, examples of which are illustrated in the accompanying drawings, wherein:

FIG. 1A is an electrical diagram of an embodiment of the energy saving control apparatus of the invention.

FIG. 1B is an electrical diagram of another embodiment of the energy saving control apparatus of the invention.

FIG. 2A is an illustration of an embodiment of the power connecting device of the invention.

FIG. 2B is an electrical diagram of the power connecting device shown in FIG. 2A.

FIG. 2C is an electrical circuit design of the power connecting device shown in FIG. 2A.

FIG. 3 is an illustration of another embodiment of the power connecting device of the invention.

FIGS. 4A, 4B and 4C are illustrations of the application examples of the power connecting devices of the invention, showing various controlling modes of the power connecting device of the invention when it cooperates with different types of electrical appliances.

FIG. 5A is an illustration of an embodiment of the switching device of the invention.

FIG. 5B is an illustration of another embodiment of the switching device of the invention.

FIG. 6A is an illustration of yet another embodiment of the power connecting device of the invention.

FIG. 6B is an electrical diagram of the power connecting device shown in FIG. 6A.

### DETAILED DESCRIPTION OF THE PREFERRED EMBODIMENT

The invention will now be described in detail through the following illustrative embodiments. However, it is understood that an element, a structure or a feature in an embodiment can be beneficially incorporated into other embodiments without further recitation.

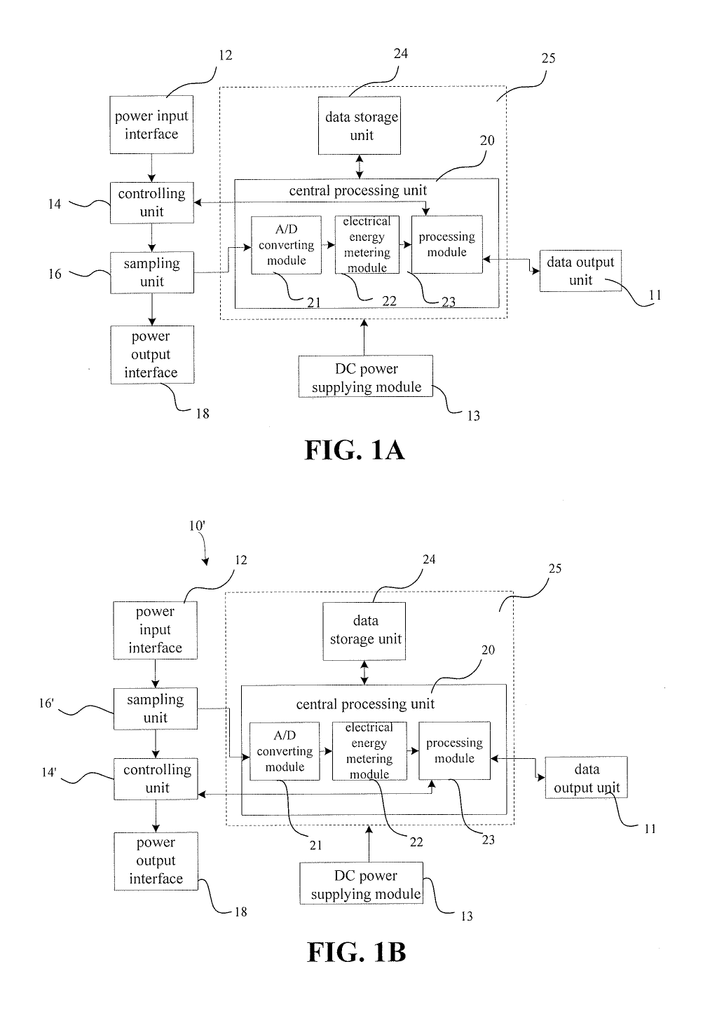

Referring to FIG. 1A, the energy saving control apparatus 10 of the invention comprises a power input interface 12 for connecting to an external power source (not shown), a power output interface 18 for connecting to an external electrical appliance (not shown), a controlling unit 14, and a sampling unit 16. The controlling unit 14 is connected to the power input interface 12, for controlling the level of the voltage or the current input from the power input interface 12 or controlling the on and off status of the power output interface 18. The sampling unit 16 is connected to the controlling unit 14 and the power output interface 18, which can collect the electricity parameters of the electric appliance when the power is on while the electric appliance is working. Further, the energy saving control apparatus 10 also comprises a core processing unit 25 that includes: a central processing unit 20 and a data storage unit 24. The central processing unit 20 is connected to both the controlling unit 14 and the sampling unit 16, for processing the output signals from the sampling unit 16 and outputting control signals to the controlling unit 14. The data storage unit 24 is connected to the central processing unit 20 for storing the data required for the operation of the central processing unit 20. The core processing unit 25 is powered by a DC power supplying module 13.

The electrical parameters of the electric appliances to be measured mainly comprise the value of effective current, the value of effective voltage, the electricity consumption of the current period, the accumulation of the total electricity consumptions, the active power and the reactive power, etc. Preferably, the sampling unit 16 comprises a current sampling unit and a voltage sampling unit.

The central processing unit 20 may consist of a special electrical energy measurement chip and auxiliary circuits for the chip. The central processing unit 20, which is the core of the whole measurement and control, comprises an A/D converting module 21 that converts the sampling signals of currents and voltages output by the sampling unit 16 to digital signals, an electrical energy metering module 22 for calculating the electricity consumption or the like, and a processing module 23 (such as 8052 MCU (Microprocessor Control Unit)).

The data storage unit 24 may consist of a piece of EEPROM of 4 KB, which is driven by an Inter-Integrated Circuit (I²C) interface of the central processing unit.

The controlling unit 14 is connected to the signal output ports of the central processing unit, to receive the controlling signal from the central processing unit. The output signals of the sampling unit 16 are transmitted to analog signals input ports of the A/D converting module 21 of central processing unit.

A data output unit 11 may be a Bluetooth module, which can communicate with other devices having Bluetooth communication modules in a Bluetooth mode, outputting the electrical parameters of the electrical appliances to external devices

Hence, when the power is on, the current of the electric appliance passes through the sampling unit 16 first. Then, a voltage sampling signal and a current sampling signal are outputted from the sampling unit 16. Those voltage and/or current sampling signals are respectively converted into digital signals by the A/D converting module 21 and then are transmitted to the electrical energy metering module 22 for calculating the electricity consumption.

After the electrical energy metering module 22 of the central processing unit transmits the calculated electrical parameters to the processing module 23, the processing module 23 writes the electrical parameter data into the data storage unit 24 (such as EEPROM). Preferably, the data storage unit 24 can store the date therein even when the power is off and can read said data out again when power is resumed. In addition, the processing module 23, after receiving the electrical parameters, can output those stored data to other storage devices via the data output unit 11. The central processing unit of the invention can also be connected to a display module to facilitate the reading of the data, or it can be connected to a communication unit to exchange data with the external devices.

Further, the controlling unit 14 of the invention can perform a feedback control to the electrical appliances under the command of software. That is, the processing module 23 of the central processing unit 20 can control the on/off status of the controlling unit 14 to realize the function of controlling the power supplies of the electrical payloads. For example, a quota can be preset for the electrical payload. When such quota is exceeded, the processing module 23 will send a controlling signal to the controlling unit 14 to shutdown the power supply of the payload of the electric appliance.

It should be understood that, according to the invention, there are many variations of this energy saving control apparatus of the invention. For example, as shown in FIG. 1B, the energy saving control apparatus 10′ of the invention can be designed so that the sampling unit 16′ is connected to the power input interface 12, the controlling unit 14′ being connected to the sampling unit 16′, the power output interface 18 being connected to the controlling unit 14′, and the central processing unit 20 being connected to both the controlling unit 14′ and the sampling unit 16′.

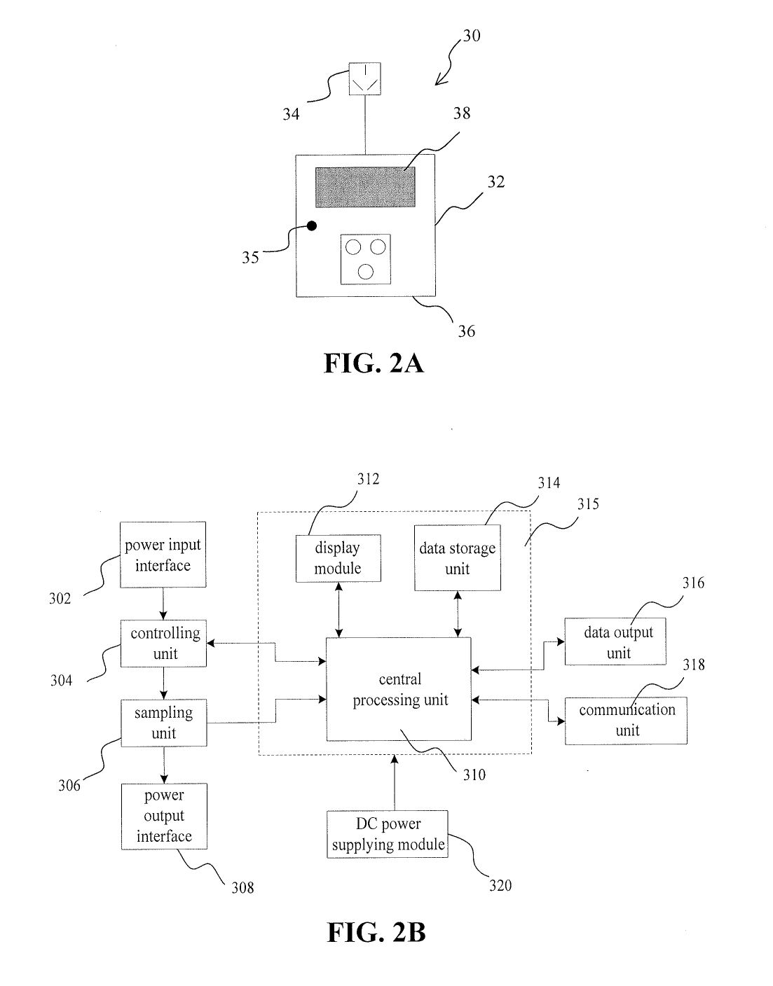

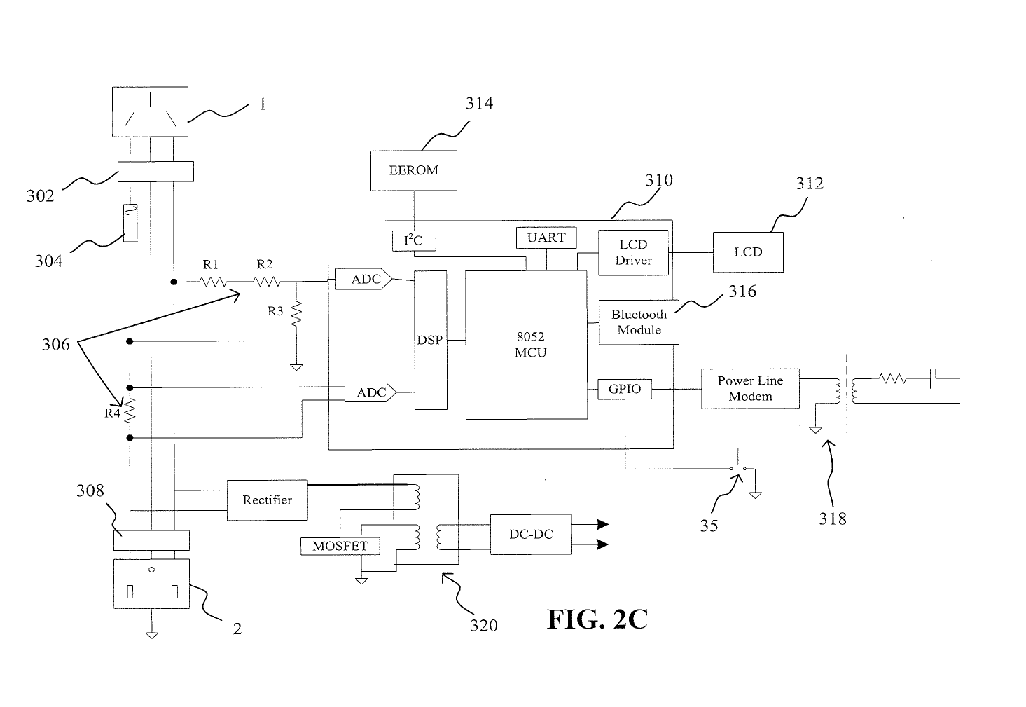

There are broad applications of the energy saving control apparatus of the invention, which can be served individually as a power connecting device to measure, store and output the electrical parameters of the electrical appliances connected to it. For example, it can be used as a power connecting device when being embodied into a packaging shell. Referring to FIG. 2A, the power connecting device 30 of the invention is equipped with a packaging shell 32, from which a power plug 34 and a power socket 36 are integrated. A LCD screen 38 can be installed inside an opening of the packaging shell 32 to facilitate the readout of the data.

Additionally, a multi-function button 35 can also be installed on the packaging shell 32 according to the invention. The multi-function button 35 can serve as a readout button. For example, it can be designed such that the electricity consumption of current period is displayed by default without pushing the button. The accumulation of total electricity consumptions, the value of effective voltage, and the value of effective current will be displayed in turn by pushing the button for a short interval. The electricity consumption of current period will be reset when pushing the button for a long interval.

As shown in FIG. 2B, similarly, the energy saving control apparatus 30 of the invention has a controlling unit 304 and a sampling unit 306 connected between the power input interface 302 and the power output interface 308. The core processing unit 315 consists of a central processing unit 310, and a displaying module 312 and a data storage unit 314 that are connected to the central processing unit 310. The sampling unit 306 and the controlling unit 304 are connected to the central processing unit 310. A DC power supplying unit 320 provides direct current for the core processing unit 315, the controlling unit 304, the sampling unit 306, the data output unit 316 and the communication unit 318.

The power connecting device of the invention is convenient and versatile for outputting data. Especially, since the data output unit 316 and the communication unit 318 are also connected to the central processing unit 310, the power connecting device of the invention can both output the data at a short range and in non-contact way and transmit the data through other communication media. Furthermore, the power connecting device of the invention can receive the control signals from other management devices through the communication unit 318, and perform energy-saving control for the electric appliances connected thereto in accordance with the received control signals.

Referring to the electrical block diagram as shown in FIG. 2C, a power plug 1 is connected to the power input interface 302, while the power socket 2 is connected to the power output interface 308. The electronic circuit board of data collection and processing is fixed on the packaging shell 32 by screws. The displaying screen 312 and the multi-function button 35 is fixed on the data collection and processing board.

The central processing unit 310 consists of a special electrical measurement chip and auxiliary circuits for the chip. The central processing unit 310, which is a core of the whole measurement and control, comprises an A/D converting module, an electrical energy metering module, a processing module (8052 MCU) and other auxiliary circuits.

The data storage unit 314 consists of a piece of EEPROM of 4 KB, which is driven by the I²C interface of the central processing unit 310. The displaying module 312 consists of an LCD screen, which is connected to the LCD driving ports of the central processing unit 310. An LCD driver is integrated within the central processing unit 310, which, by means of the programmed software, can directly display the measured electrical data inputted to a processing module (MCU) via the LCD screen.

The controlling signals of the controlling unit 304 are connected to the signal output ports of the central processing unit, while the sampling signals of the sampling unit 306 are connected to the analog input ports of the A/D convertor of the central processing unit 310.

The data output unit 316 can be of for example Bluetooth module, which can communicate with other communication devices having Bluetooth communication modules in a Bluetooth mode. However, it should be understood that the data output manner according to the invention is not limited to the Bluetooth communication mode as described in this embodiment. Other communication modes such as RF data output mode, Zigbee data output mode, or wired communication mode etc. are also viable for the invention.

The communication unit 318 can be a PLC (Power Line Communication) module, which comprises a PLC modulation-demodulation chip (Power Line Modem) and power amplifying circuit and other auxiliary circuits. The data input ports of the PLC module are driven by the GPIO (General Purpose Input Output) of the central processing unit 310.

The DC power supplying module 320 converts the high voltage AC inputted from the power lines into high voltage DC through a rectifier, wherein the voltage of inputted AC can be in the range of 85V to 240V. A higher frequency transformer connected to the rectifier reduces the voltage of the rectified high voltage DC and generates 12V voltage DC, which can be outputted to supply the central processing unit. A DC-DC module connected to the transformer can subsequently generate 5V and 3.3V voltage DC for supplying power to other chips.

The multi-function button 35 is a readout button. The electricity consumption of the current period is displayed by default without pushing the button. The accumulation of total electricity consumptions, the value of effective voltage, and the value of effective current will be displayed in turn by pushing the button for a short interval. The electricity consumption of current period will be reset when pushing the button for a long interval.

When the controlling unit 304 of this invention is on, the electrical current used by the payload passes through the sampling unit 306 first, the sampling circuit of which consists of a voltage sampling module and a current sampling module. The voltage sampling can be realized by resistor voltage dividing. Here, three series resistors R1, R2 and R3 are used. The smaller divided voltage of the resistor R3 is collected and inputted to the central processing unit 310. The A/D converting module embedded in the central processing unit converts the analogue voltage signal into digital value and then inputs the digital value to the electrical energy metering module. The value of the voltage in the circuit can be calculated by the electrical energy metering module. The electrical current sampling can be done by connecting a resistor R4 of very small resistance value in series into the circuit, and then sampling the voltage deduction on R4, inputting the sampled AD voltage signal into the A/D converting module of the central processing unit to convert the signal into a small digital value. The value of the current can be calculated from the small digital voltage value by the DSP (Digital Signal Processing) chip. The value of the current can be outputted also to the electrical energy metering module.

After the electrical energy metering module of the central processing unit inputs the calculated electrical parameters of the loads into the MCU, the MCU writes the data into the data storage unit 314 (such as EEPROM) via the I²C interface. The data storage unit 314 can store the data even when the power is off, and can read them out when the power is resumed next time. At same time, MCU drives the displaying unit 312 (such as LCD) through the LCD driver to display the electrical parameters.

The data output unit 316 can be of a Bluetooth communication module, which consists of an RF transceiver and a high performance Bluetooth baseband processing module and supports the technical standard Bluetooth 1.2. After the electrical parameters are inputted to MCU, MCU can transmit those stored data to other storage devices having Bluetooth function via the Bluetooth communication module.

Also, under the control of software, the controlling unit 304 can perform feedback control for the electrical appliances. One preferable embodiment of the invention is constructed with a communication module, allowing it to receive the control signals sent from other controlling devices (not shown) via the communication unit 318. Those controlling signals are demodulated from the electrical power lines by the communication unit 318 and then inputted to MCU via GPIO. Then the MCU, according to the inputted signals, can further control the on/off status of the controlling unit 304, or adjust the voltage or current level of the power circuit of the electrical appliance, so as to achieve the purpose of energy saving control.

It is understood that, according to the technical solution of the invention, the power connecting device having energy saving control apparatus of the invention can also be designed in such a way that the sampling unit is connected to the power input interface, the controlling unit being connected to the sampling unit, the power output interface being connected to the controlling unit, and the central processing unit being connected to both the controlling unit and the sampling unit.

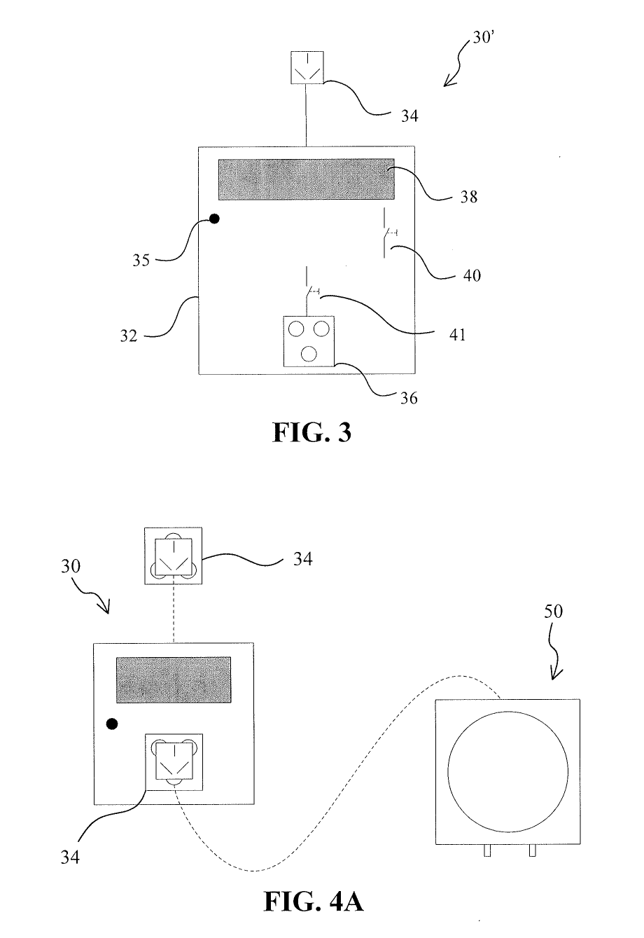

Of course, there are special circumstances where a manual intervention is needed for the application of the power connecting device 30. As shown in FIG. 3, the power connecting device 30′ of the invention is further equipped with two manual switches 40 and 41. The manual switch 40 is used to select the control mode of the power output connector to be either manually controlled or automatically controlled by the electronic circuit. If the switch 40 is closed, the central processing unit will determine the on/off status of the power output connector according to a threshold or the management instructions it received. If the switch 40 is open, the on/off status of the power output connector is determined by the manual switch 41. If the switch 41 is closed the power will be supplied to the appliances from the power output interface. At this time, the electric appliances will be supplied electrical current by the power output connector when the switch 41 is closed, and be shut down when switch 41 is open. That is, according to the user's requirement, the power connecting device 30′ of the invention can start the manual control mode to keep the electric appliances at power on state, even when the central processing unit has issued the off signal to the controlling unit.

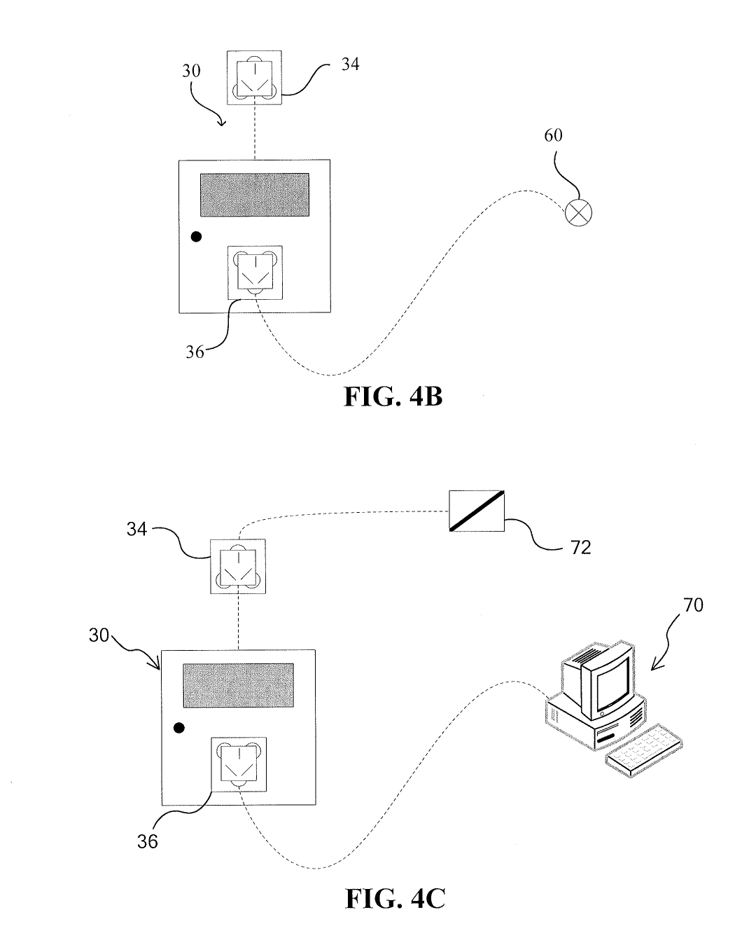

Since the energy saving control apparatus of the invention can be used as a stand-alone apparatus, the power connecting device equipped with said energy saving control apparatus can be widely used in households or office environment alike. For example, FIG. 4A illustrates the schematic diagram of the power connecting device 30 of the invention performing switching feedback control to a drinking machine 50 externally connected thereto. In this embodiment, the controlling unit can be a relay switch. The power plug 34 of the power connecting device is plugged into the household electricity socket while the power plug of the drinking machine 50 is plugged into the socket 36 of the power connecting device 30.

At the same time, a threshold can be preset in the central processing unit for limiting the amount of the daily electrical consumption of the drinking machine 50. The data of the electrical consumption calculated by the electrical energy metering module of the central processing unit is sent to the MCU. Then, the MCU stores the calculated data and compares it with the threshold. If, during a preset time period (for example one day), the actual electricity consumption of the drinking machine is smaller than the threshold, there will be no feedback action from the MCU. However, if the actual electricity consumption of the drinking machine is larger than the threshold, the MCU will send out a shut-down control signal via GPIO port to the controlling unit. The controlling unit (relay switch) will be shut down then. Thus, the daily electricity usage of the drinking machine is effectively controlled, and, more importantly, prevents the drinking machine being on during off-work time.

Additionally FIG. 4B illustrates the schematic diagram of the power connecting device 30 of the invention performing the current-limiting feedback control to an external connected light bulb 60. In this embodiment, a current limiting resistor can be used in the controlling unit. The resistance of said current limiting resistor, which is a series-connected in the circuit, is controlled by the GPIO of the MCU of the central processing unit. The plug 34 of the power connecting device 30 is plugged into the socket of household power source, while the plug of light bulb 60 is plugged into the socket 36 of the power connecting device. Alternatively, the power input port of the light bulb 60 can be directly connected to the power output port of the power connecting device.

Similarly, a threshold can be preset in the central processing unit, for limiting the amount of the daily electricity consumption of the light bulb. The data of the electricity consumption calculated by the electrical energy metering module of the central processing unit is sent to the MCU. Then, the MCU stores the calculated data and compares it with the threshold. If, during a preset time period (for example one day), the actual electricity consumption of the light bulb is smaller than the threshold, there will be no feedback action from the MCU. However, if the actual electricity consumption of the light bulb is larger than the threshold, the MCU will send out a shut-down control signal via GPIO port to the controlling unit (i.e. the current limiting resistor), to increase the resistance of the current limiting resistor. Thus, the electricity consumption of the light bulb is effectively controlled, achieving the purpose of energy saving.

Further, FIG. 4C illustrates the schematic diagram of the power connecting device 30 of the invention connected with an external computer 70 to perform power supply feedback control by receiving remote instructions. The plug 34 of the power connecting device 30 is plugged into the socket of the power supply source, while the plug of computer 70 is plugged into the socket 36 of the power connecting device. A central controlling module 72 is further arranged in the power lines, which can communicate with the communication unit 318 of the power connecting device 30 to exchange data and/or transmit the control instructions through a communication unit of said central controlling module 72.

Similarly, a threshold can be preset in the central processing unit, for limiting the amount of the electricity consumption of the computer during a specified time period. The data of the electricity consumption calculated by the electrical energy metering module of the central processing unit is outputted to the MCU. The MCU stores the calculated data and compares it with the preset threshold. If, during the specified time period, the actual electricity consumption of the computer is smaller than the threshold, there will be no feedback controlling action from the MCU.

Otherwise, if the electricity consumption is larger than the preset threshold, the MCU will send a signal to the central controlling module 72 through the communication unit, making the central controlling module 72 decide whether the power of the computer 70 should be shutdown or not. If the central controlling module 72 sends instruction to the power connecting device 30 to demand the shut down of the power supply of said computer, a controlling signal will be outputted from the GPIO of the MCU to the controlling unit, enabling the controlling unit (such as a relay switch in this case) to be off, hence cutting off the power of the computer. A practical utilization of such an application is to reduce the wasting of energy for the idled computer when the worker is off duty but forgets to turn the computer off. The central controlling device 72 can also send instructions directly to the power connecting device to directly control the power supply of the computer 70.

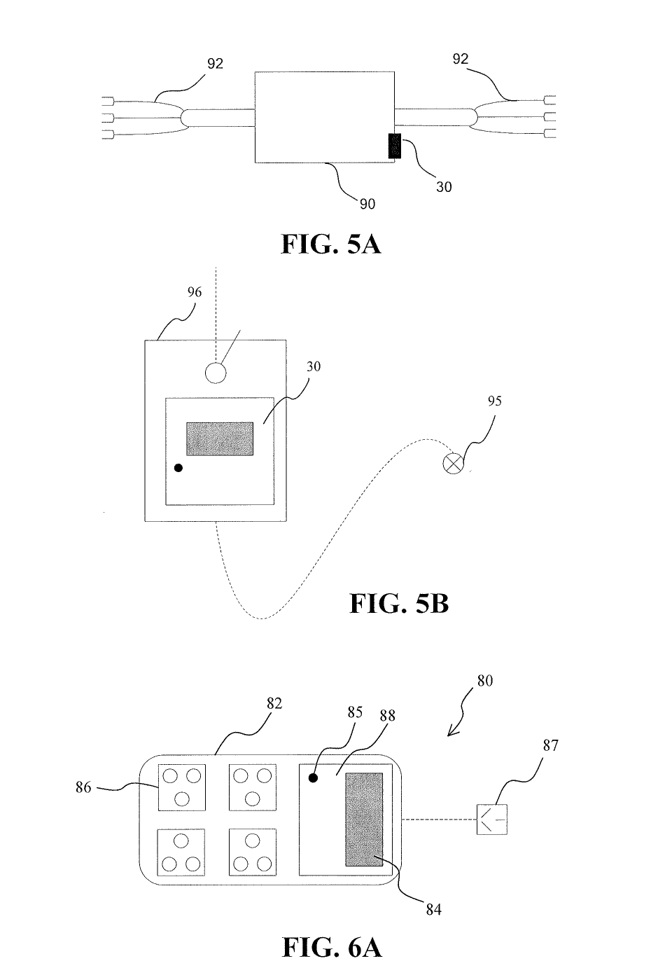

In practical applications, the energy saving control apparatus of the invention has a compact size and excellent integration ability, which is suitable to be integrated with existing electrical appliances and systems, and is also suitable to be embedded into existing power connecting devices or switching devices. FIG. 5A illustrates the schematic view of the energy saving control apparatus of the invention embedded into a switching device such as a power distribution panel. In this embodiment, the communication unit of the energy saving control apparatus transmits data through signal lines. The energy saving control apparatus 30 of the invention is installed inside a sealed box 90. A set (e.g. three) of connecting terminals 92, 94 are connected to each of the power input interface and power output interface and extended to the outside of the box 90. Three connecting terminals 92 from the power input interface are connected with the power input ports of the circuits in the power distribution panel, while three connecting terminals 94 from the power output interface are connected with the corresponding power output ports of the circuits in the power distribution panel. The whole apparatus is fixed at a suitable location in the power distribution panel, and is thus able to measure, store and control the electrical parameters of the circuits of the power distribution panel.

FIG. 5B illustrates another embodiment of the energy saving control apparatus of the invention embedded into a switching device. In this embodiment, the input of electricity passes through one end of the switching device 96. The energy saving control apparatus 30 of the invention is embedded inside the switching device 96, while the other end of the switching device 96 is connected with an electrical equipment 95. Thus, through the energy saving control apparatus 30, the switching device 96 can not only provide power supply to the electrical equipment 95, but also have the ability of measuring, controlling and displaying the electrical parameters of said electrical equipment.

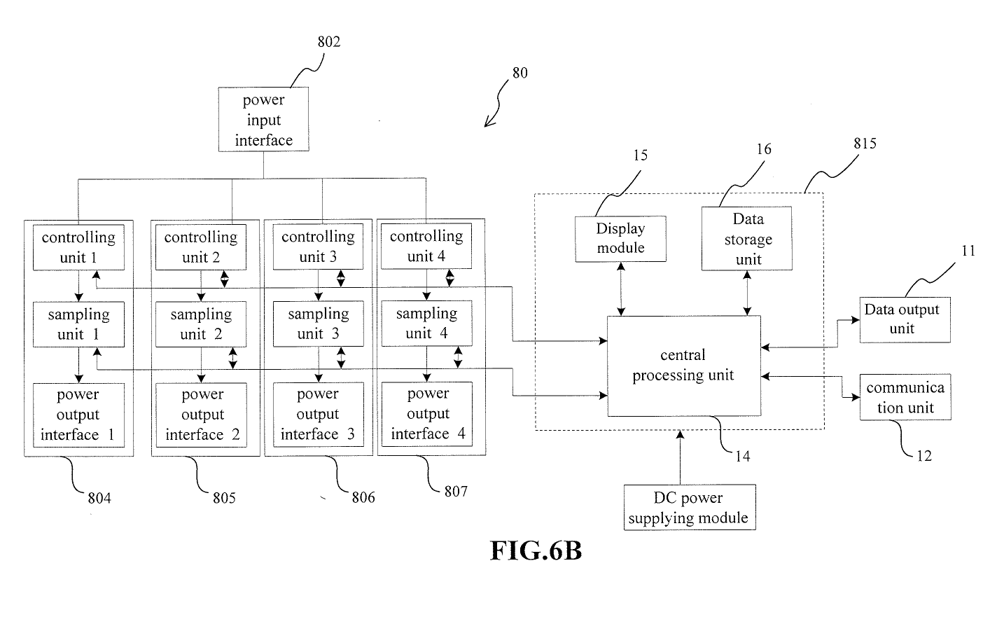

In addition to constructing of a stand-alone power connecting device with the function of measuring and controlling of the electrical parameters, a more specific application of the energy saving control apparatus of the invention is to be embedded into existing power connecting devices with sockets (such as a power strip with six sockets in double rows), allowing the power strip have the functions of measuring, displaying and controlling the electrical parameters, so that the power strip can control the electrical parameters of the electric equipments connected thereto. FIG. 6A illustrates the diagram of such an energy saving control apparatus embedded into an existing power connecting device with multiple sockets. Here, the power connecting device 80 has four sockets 86 for electric equipments (not shown) plugging in. The energy saving control apparatus of the invention (not shown in FIG. 6A) is embedded inside the box 82 of the power connecting device 80. A displaying window 84 can be implemented at the top of the box 82. The whole energy saving control apparatus is embedded inside the displaying window 84 that is sealed by Plexiglas 88. A round hole is opened on the Plexiglas 88 so that the multi-function button 85 can go through the hole. The LCD display screen of the energy-saving control apparatus is installed above the electrical board so that it can be read through the display window 84.

With respect to the embedding modes, the power connecting device 80 has four groups of the sampling units and controlling units embedded therein and is connected to the core processing unit 815. As shown in FIG. 6B, according to a preferred embodiment of the invention, four set of sampling-controlling circuits 804, 805, 806 and 807 are integrated within one body, wherein the power output interface, the sampling unit and the controlling unit of one group are considered as one set of sampling-controlling circuit.

When the plug 87 of the power connecting device 80 of the invention is plugged into the electricity supply circuit while four electric appliances (not shown) are plugged into the respective sockets 86, the voltage or current signals are obtained by sampling the electrical current passing through the respective electric appliances by the respective sampling units, and then are inputted into the electrical energy metering module for the calculation of respective electrical parameters. The calculated electrical parameters can be sent to the EEPROM for storage, and also can be displayed by the LCD screen. The electrical parameters of the electric equipment to be displayed can be selected by pushing the button 85.

Although several preferred embodiments of the present invention have been described, the present invention may be used with other configurations. It will be appreciated by those skilled in the art that the present invention could have many other embodiments, and changes and modifications may be made thereto without departing from the invention in its broader aspects and as set forth in the following claims and equivalents thereof.

1. An energy saving control apparatus, comprising:
a power input interface configured to connect to an external power source;
a power output interface configured to connect to an external electric appliance;
a controlling unit configured to control the level of the voltage or amperage transmitted from the power input interface to the power output interface, or controlling the on and off of the power output interface;
a sampling unit for collecting and outputting electricity parameter(s) of the external electric appliance;
a central processing unit connected to the controlling unit and the sampling unit respectively to process output signals from the sampling unit and output controlling signals to the controlling unit; and
a data storage unit connected to the central processing unit to store the data necessary for the operation of the central processing unit.

2. The energy saving control apparatus according to claim 1, wherein the central processing unit comprises:
an Analog-to-Digital (A/D) converting module connected to the sampling unit to receive and digitize the output signals from the sampling unit;
an electrical energy metering module connected to the A/D converting module to calculate the electricity consumption; and
a processing module, an input port of which is connected to the electrical energy metering module and an output port of the processing module is connected to the controlling unit.

3. The energy saving control apparatus according to claim 2, wherein the sampling unit includes at least one of a voltage sampling module and a current sampling module.

4. The energy saving control apparatus according to claim 3, wherein the processing module of the central processing unit is connected to the data storage unit.

5. The energy saving control apparatus according to claim 4, wherein the processing module is connected to a data output unit.

6. The energy saving control apparatus according to claim 5, wherein the processing module is connected to a communication unit to exchange data with external system through said communication unit.

7. The energy saving control apparatus according to claim 6, wherein the processing module is connected to a display module.

8. The energy saving control apparatus according to claim 7, further comprising a button for inquiring the measured electricity parameter of the electric appliance.

9. The energy saving control apparatus according to claim 1, wherein the controlling unit and the sampling unit are connected in series between the power input interface and the power output interface, wherein the power input interface is connected to one of the controlling unit and the sampling unit, while the other one of the controlling unit and the sampling unit is connected to the power output interface.

10. (canceled)

11. A power connecting device having an energy saving control apparatus of claim 1, comprising:
a power input interface configured to connect to an external power source;
at least one power output interface configured to connect to at least one external electric appliance;
wherein said energy saving control apparatus comprises
at least one controlling unit configured to control the level of the voltage or amperage transmitted from the power input interface to the power output interface, or controlling the on and off of the power output interface;
at least one sampling unit for collecting and outputting electricity parameter(s) of the at least one external electric appliance;
a central processing unit connected to the at least one controlling unit and the at least one sampling unit respectively to process output signals from the at least one sampling unit and output controlling signals to the corresponding controlling unit; and
a data storage unit connected to the central processing unit to store the data necessary for the operation of the central processing unit.

12. The power connecting device according to claim 11, wherein the central processing unit comprises
an Analog-to-Digital (A/D) converting module connected to the at least one sampling unit to receive and digitize the output signals from the at least one sampling unit;
an electrical energy metering module connected to the A/D converting module to calculate the electricity consumption; and
a processing module, an input port of which is connected to the electrical energy metering module and an input port of which is connected to the at least one controlling unit.

13. The power connecting device according to claim 12, wherein each of the sampling unit includes at least one of a voltage sampling module and a current sampling module.

14. The power connecting device according to claim 13, wherein the processing module of the central processing unit is connected to the data storage unit.

15. The power connecting device according to claim 14, wherein the processing module is connected to a data output unit.

16. The power connecting device according to claim 15, wherein the processing module is connected to a communication unit to exchange data with external system through said communication unit.

17. The power connecting device according to claim 16, wherein the processing module is connected to a display module.

18. The power connecting device according to claim 17, further comprising a button for inquiring the measured electricity parameter of the electric appliance.

19. The power connecting device according to claim 11, wherein the corresponding controlling unit and sampling unit are connected in series between the power input interface and the power output interface, wherein the power input interface is connected to one of said controlling unit and said sampling unit, while the other one of said controlling unit and said sampling unit is connected to the power output interface.

20. (canceled)

21. The power connecting device according to claim 11, wherein the energy saving control apparatus further comprises:
a first manual switch for switching between a manual control mode and an automatic control mode; and
a second manual switch cooperated with the first manual switch to control the on/off status of the power output interface when the first manual switch is switched into the manual control mode.

22. A switching device, comprising at least one of the energy saving control apparatus according to claim 1.
